(19) United States
(12) Patent Application Publication
(10) Pub. No.: US 2025/0171059 A1
(43) Pub. Date: May 29, 2025

(54) TECHNIQUES FOR DETECTING RAIL OXIDATION AFFECTING TRACK CIRCUITS

(71) Applicant: Progress Rail Signaling S.p.A., Serravalle Pistoiese (IT)

(72) Inventor: Filippo Salotti, Lucca (IT)

(73) Assignee: Progress Rail Signaling S.p.A., Serravalle Pistoiese (IT)

(21) Appl. No.: 18/523,201

(22) Filed: Nov. 29, 2023

(51) Int. Cl. B61K 9/08; G01N 27/04; G01N 27/20

(52) U.S. Cl. CPC B61K 9/08; G01N 27/041; G01N 27/20

(57) ABSTRACT

Techniques describe include a system for detecting oxidation of a rail of a track. The system includes a first pair of sensors configured to detect a first portion of a current through the rail of the track and a second pair of sensors configured to detect a second portion of the current through the rail of the track. The system includes a controller configured to receive a first signal representing a measurement of the first portion of the current, receive a second signal representing a measurement of the second portion of the current, compare the measurement of the first portion of the current and the measurement of the second portion of the current, determine, based on the comparison, a status of the oxidation, and generate and transmit a signal representing the status of the oxidation.

### TECHNICAL FIELD

This disclosure relates generally to detecting oxidation affecting a rail of a track.

### BACKGROUND

Rail transportation is a crucial element of the global transportation infrastructure, playing a key role in the movement of goods, people, and services worldwide. Ensuring the safety, efficiency, and smooth operation of rail networks requires effective methods for detecting the presence of trains on tracks.

One approach to detection involves applying a voltage to inject a small current onto a rail of a track to detect the presence of a train within a section of track. This approach to train detection works based on the principles of electric circuits and conductivity. In a standard electric circuit, the presence of a conductor between two points allows for the flow of electric current. In the case of rail tracks, the rails themselves act as conductors. When a train is not present on a section of track, the circuit is open, and the current cannot flow from one rail to the other. However, when a train moves onto a section of track, the train wheels and axle form a shunt between the rails, allowing the current to flow through the shunt, which indicates the presence of a train.

By monitoring the flow of this small, injected current, it is possible to accurately detect the presence and absence of trains on a track section. This information can then be used to control signals, switch tracks, and maintain safe and efficient operation of the rail network.

JP4159888B2 describes removing or destroying an insulating coating formed on a rail surface by applying a predetermined voltage between the left end portions or the right end portions of the front and rear axles installed at the front and rear of a railway vehicle bogie. As a result, it is possible to improve the short-circuit failure caused by the short-circuit resistance between the wheel tread and the rail, and it is possible to more reliably short-circuit the left and right rails by the wheel and the axle.

### SUMMARY

This disclosure describes techniques for detecting oxidation of a rail of a track.

In some aspects, this disclosure is directed to a system for detecting oxidation of a rail of a track, the system comprising: a first pair of sensors affixed adjacent to a first portion of a rail car and configured to detect a first portion of a current through the rail of the track; a second pair of sensors affixed adjacent to a second portion of the rail car and configured to detect a second portion of the current through the rail of the track; a controller affixed to the rail car and in electrical communication with the first pair of sensors and the second pair of sensors, the controller configured to: receive, from the first pair of sensors, a first signal representing a measurement of the first portion of the current; receive, from the second pair of sensors, a second signal representing a measurement of the second portion of the current; compare the measurement of the first portion of the current and the measurement of the second portion of the current; determine, based on the comparison, a status of the oxidation; and generate and transmit a signal representing the status of the oxidation.

In some aspects, this disclosure is directed to a method for detecting oxidation of a rail of a track, the method comprising: receiving a first signal representing a measurement of a first portion of a current through the rail of the track; receiving a second signal representing a measurement of a second portion of a current through the rail of the track; comparing the measurement of the first portion of the current and the measurement of the second portion of the current; determining, based on the comparison, a status of the oxidation; and generating and transmitting a signal representing the status of the oxidation.

In some aspects, this disclosure is directed to a controller for detecting oxidation of a rail of a track, the controller configured to perform operations comprising: receiving a first signal representing a measurement of a first portion of a current through the rail of the track; receiving a second signal representing a measurement of a second portion of a current through the rail of the track; comparing the measurement of the first portion of the current and the measurement of the second portion of the current; determining, based on the comparison, a status of the oxidation; and generating and transmitting a signal representing the status of the oxidation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a conceptual diagram illustrating an example of a system for detecting oxidation of a rail of a track, in accordance with this disclosure.

FIG. 2 is a flow diagram of an example of a method for detecting oxidation of a rail of a track, in accordance with this disclosure.

### DETAILED DESCRIPTION

In some approaches, detecting whether a rail car is engaged with a track section is accomplished by applying a voltage (AC or DC) to inject a small current on a rail at the beginning of the track section and observing the voltage at the end of the track section, such as by use of a relay. When the rail car engages the section, the wheels and axle of the rail car can shunt the current, which operates the relay.

This method of detection requires no contact with the trains themselves and causes no disruption to normal rail operations. Moreover, it can provide accurate and reliable results, even in poor weather conditions or low visibility, making it a valuable tool for modern rail systems. Despite these advantages, the injected current method also has its challenges. For instance, the presence of rust, dirt, or other non-conductive materials on the tracks can interfere with the current and potentially result in false readings. For example, oxidation of rail and rail joints can prevent this method from working effectively.

In Europe, signaling trains can detect the shunt currents by means of “track circuit detectors” mounted on the front and rear of the rail car in order to repeat on board information coded on the track circuits.

A problem recognized by the present inventor is that although diagnostic rail cars exist that can verify infrastructure integrity, these diagnostic rail cars do not verify the capability of the rails to be shunted by the rail car in terms of conductivity of the track circuits. If the rail of the track section is highly oxidized, the contact between the wheel of the rail car and the rail is poor and the rail car cannot shunt the current applied to the rail. In such a scenario, the rail car can pass over the track section, but the presence of the rail car cannot be detected, which presents safety concerns. The present inventor has recognized a need for an improved technique to detect the presence of a rail car on a track section.

This disclosure describes techniques for detecting oxidation of a rail of a track. A proposed solution provides an on-board diagnostic system that uses track current sensors that are placed in the front and rear positions of a rail car. The on-board diagnostic system identifies the occurrence of rail oxidation based on the current detected by the current sensors. If the sensors on the rear axle of the rail car detect a current value of about 0 amperes, then the rails are in good galvanic condition because all current is shunted by the front axle of the rail car. In this condition, all of the current is detected by the sensors on the front axle of the rail car. However, if the sensors on the rear axle of the rail car output a non-zero current value, then current is present at the rear axle, which indicates that the rail is oxidized. In this disclosure, a rail car refers to a first or last portion of a train, such as, but not limited to, the engine, the individual units where passengers, cargo, or both are carried, and undercarriage assemblies (e.g., bogies) that are used to support the car, as well as a standalone diagnostic rail car.

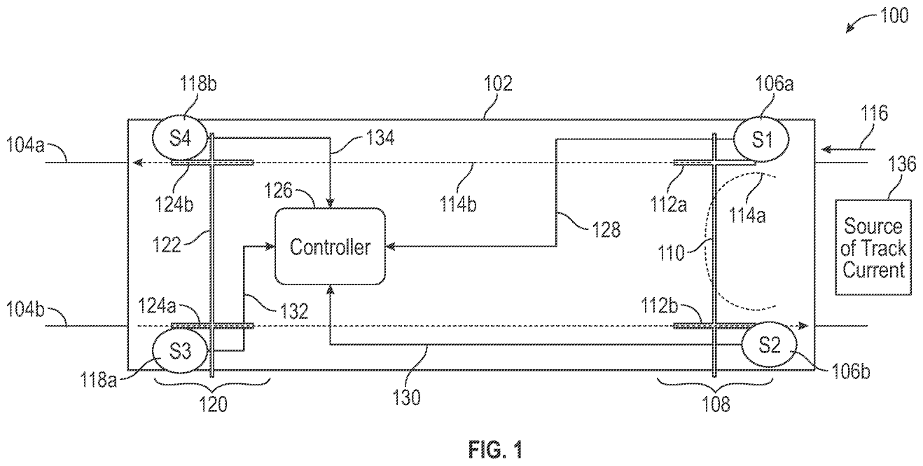

FIG. 1 is a conceptual diagram illustrating an example of a system for detecting oxidation of a rail of a track, in accordance with this disclosure. FIG. 1 depicts a rail car 102 positioned on a first rail 104a and a second rail 104b of a track section of a railway track.

The system 100 includes a first pair of sensors, namely sensor 106a (S1) and sensor 106b (S2), which are affixed adjacent to a first portion 108 of the rail car 102. For example, the first portion 108 of the rail car 102 includes a first axle 110, where the first axle 110 is coupled with a first pair of wheels, namely wheel 112a and wheel 112b. The first pair of sensors is configured to detect a first portion of a first portion 114a of a current 116 through the first rail 104a of the track. The current 116 is provided by a source of track current 136.

The system 100 further includes a second pair of sensors, namely sensor 118a (S3) and sensor 118b (S4), which are affixed adjacent to a second portion of the rail car 102. For example, the second portion of the rail car 102 includes a second axle 122, where the second axle 122 is coupled with a second pair of wheels, namely wheel 124a and wheel 124b. The second pair of sensors is configured to detect a second portion 114b of the current 116 through the first rail 104a of the track.

As mentioned above, in some examples, the current 116 can be a DC current, such as used in the United States. As such, at least one of the first pair of sensors and the second pair of sensors is configured to detect a DC current. For example, at least one of the first pair of sensors and the second pair of sensors includes a Hall effect sensor to detect a DC current.

In other examples, the current 116 can be an AC current, such as used in Europe. As such, at least one of the first pair of sensors and the second pair of sensors is configured to detect an AC current. For example, at least one of the first pair of sensors and the second pair of sensors includes a current transformer to detect an AC current.

When there is little or no oxidation on the first rail 104a and the second rail 104b, the conductivity between the wheel 112a and the first rail 104a and the wheel 112b and the second rail 104b is high and all of the current 116 is shunted through the first axle 110 such that the second portion 114b of the current 116 is zero and the first portion 114a of the current 116 is non-zero. Detection of any current by the second pair of sensors indicates that oxidation has prevented the wheel 112a, wheel 112b, and the first axle 110 from shunting all of the current 116.

The system 100 includes a controller 126 affixed to the rail car 102 and in electrical communication with the first pair of sensors and the second pair of sensors. In some examples, the first pair of sensors and the second pair of sensors are in wired electrical communication with the controller 126. In other examples, the first pair of sensors and the second pair of sensors are in wireless electrical communication with the controller 126.

The controller 126 is configured to receive, from the first pair of sensors, a first signal, such as including a signal 128 from the sensor 106a and a signal 130 from the sensor 106b. The first signal represents a measurement of the first portion 114a of the current 116. The first signal can be an analog signal or a digital signal.

The controller 126 is configured to receive, from the second pair of sensors, a second signal, such as including a signal 132 from the sensor 118a and a signal 134 from the sensor 118b. The second signal represents a measurement of the second portion 114b of the current 116. The second signal can be an analog signal or a digital signal.

The controller 126 is configured to compare the measurement of the first portion of the current and the measurement of the second portion of the current and determine, based on the comparison, a status of the oxidation. In some examples, the controller 126 can compare the two by determining a ratio of the measurement of the first portion of the current and the measurement of the second portion of the current, and then comparing the ratio to a threshold value.

By way of a non-limiting example solely for the purposes of explanation, the total current 116 injected onto the first rail 104a can be 0.5 amperes, where the first portion 114a of the current 116 can be 0.4 amperes and the second portion 114b of the current 116 can be 0.1 amperes. The controller 126 is configured to receive, from the first pair of sensors, a first signal that represents 0.4 amperes, as measured by the sensor 106a and the sensor 106b. For example, the sensor 106a measures 0.4 amperes, which the sensor 106a transmits as signal 128 to the controller 126, and the sensor 106b measure 0.4 amperes, which the sensor 106b transmits as signal 130 to the controller 126. Similarly, the controller 126 is configured to receive, from the second pair of sensors, a second signal that represents 0.1 amperes, which the sensor 118a transmits as the signal 132 to the controller 126, and the sensor 118b transmits as signal 134 to the controller 126.

The controller 126 can compare the two measurements represented by the received signals. For example, the controller 126 can determine a ratio of the two portions of current. If there is no oxidation, the wheel 112a, the wheel 112b, and the first axle 110 would shunt all of the current such that the second portion 114b of the current 116 would be 0 amperes, and the ratio would be 0/0.5. As such, a value of 0 indicates no oxidation and a value between 0 and 1 indicates some oxidation. Here, in this non-limiting example, only some of the current is shunted by the wheel 112a, the wheel 112b, and the first axle 110. The controller 126 can determine a ratio of 0.1/0.4=0.25, which is a status of the oxidation or an “oxidation index”. Then, the controller 126 can generate and transmit a signal representing the status of the oxidation. As an example, the controller 126 can transmit a representation of the numerical value, e.g., 0.25 in this non-limiting example.

In some examples, the controller 126 can compare the status of the oxidation to a threshold value. For example, the controller 126 can compare the value of 0.25 to a threshold value, such as 0.5. If the value is less than the threshold value, then the controller can generate and transmit a signal indicating that the oxidation is below the threshold value. If the value is equal to or greater than the threshold value, then the controller can generate and transmit a signal indicating that the oxidation is equal to or greater than the threshold value. In other examples, the controller 126 can generate and transmit a signal indicating a qualitative measurement, such as relative to the threshold value.

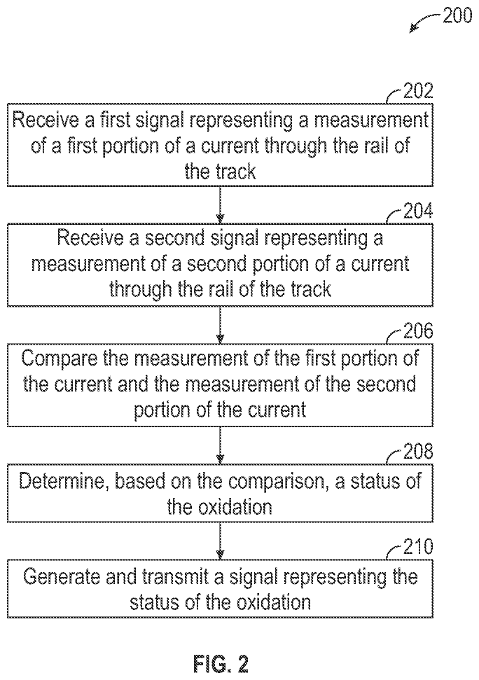

FIG. 2 is a flow diagram of an example of a method 200 for detecting oxidation of a rail of a track, in accordance with this disclosure. A controller, such as the controller 126 of FIG. 1, can perform the operations described with respect to the method 200. In block 202, the method 200 receives a first signal representing a measurement of a first portion of a current through the rail of the track.

In block 204, the method 200 receives a second signal representing a measurement of a second portion of a current through the rail of the track.

In block 206, the method 200 compares the measurement of the first portion of the current and the measurement of the second portion of the current.

In block 208, the method 200 determines, based on the comparison, a status of the oxidation. In block 210, the method 200 generates and transmits a signal representing the status of the oxidation.

In some examples, the method 200 includes determining a ratio of the measurement of the first portion of the current and the second measurement of the second portion of the current and comparing the ratio to a threshold value.

In some examples, the method 200 includes generating the first signal from at least one Hall effect sensor. In other examples, the method 200 includes generating the first signal from at least one current transformer.

In some examples, the method 200 includes wirelessly transmitting the first signal to a controller.

In some examples, the method 200 includes detecting the first signal from a first pair of sensors, wherein the first pair of sensors is configured to detect a DC current. In other examples, the method 200 includes detecting the first signal from a first pair of sensors, wherein the first pair of sensors is configured to detect an AC current.

### INDUSTRIAL APPLICABILITY

This disclosure describes techniques for detecting oxidation of a rail of a track. A technique for detecting oxidation of a rail of a train track can have significant industrial applicability, particularly in the maintenance and safety aspects of railway infrastructure. The primary industrial applicability of a technique for detecting the presence of a train on the rail track lies in its potential to significantly enhance railway safety. By accurately and reliably identifying the presence of a train, railway operators can implement appropriate safety measures to prevent collisions and ensure smooth train operations.

The technique can also serve as a critical component of railway signaling and control systems. By promptly detecting the presence of a train, the system can automatically activate warning signals, control signals, and barriers at level crossings to prevent accidents involving vehicles or pedestrians.

Further, real-time detection of trains can also assist in optimizing traffic management on busy rail networks. By precisely tracking the location of trains, the technique can help regulate train spacing, avoid congestion, and improve overall operational efficiency.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

1-20. (canceled)

21. A system for detecting oxidation of a rail of a track, the system comprising:
a first pair of sensors affixed adjacent to a first portion of a rail car and configured to detect a first portion of a current through the rail of the track;
a second pair of sensors affixed adjacent to a second portion of the rail car and configured to detect a second portion of the current through the rail of the track;
a controller affixed to the rail car and in electrical communication with the first pair of sensors and the second pair of sensors, the controller configured to:
receive, from the first pair of sensors, a first signal representing a measurement of the first portion of the current;
receive, from the second pair of sensors, a second signal representing a measurement of the second portion of the current;
compare the measurement of the first portion of the current and the measurement of the second portion of the current;
determine, based on the comparison, a status of the oxidation; and
generate and transmit a signal representing the status of the oxidation.

22. The system of claim 21, wherein the controller configured to compare the measurement of the first portion of the current and the measurement of the second portion of the current is configured to:
determine a ratio of the measurement of the first portion of the current and the measurement of the second portion of the current; and
compare the ratio to a threshold value.

23. The system of claim 21, wherein at least one of the first pair of sensors and the second pair of sensors includes a Hall effect sensor.

24. The system of claim 21, wherein at least one of the first pair of sensors and the second pair of sensors includes a current transformer.

25. The system of claim 21, wherein the first portion of the rail car includes a first axle and the second portion of the car includes a second axle.

26. The system of claim 21, wherein at least one of the first pair of sensors and the second pair of sensors is configured to detect a DC current.

27. The system of claim 21, wherein at least one of the first pair of sensors and the second pair of sensors is configured to detect an AC current.

28. The system of claim 21, wherein the controller is in wireless electrical communication with the first pair of sensors and the second pair of sensors.

29. The system of claim 21, wherein the controller is in wired electrical communication with the first pair of sensors and the second pair of sensors.

30. A method for detecting oxidation of a rail of a track, the method comprising:
receiving a first signal representing a measurement of a first portion of a current through the rail of the track;
receiving a second signal representing a measurement of a second portion of a current through the rail of the track;
comparing the measurement of the first portion of the current and the measurement of the second portion of the current;
determining, based on the comparison, a status of the oxidation; and
generating and transmitting a signal representing the status of the oxidation.

31. The method of claim 30, wherein comparing the first measurement of the first portion of the current and the measurement of the second portion of the current includes:
determining a ratio of the measurement of the first portion of the current and the second measurement of the second portion of the current; and
comparing the ratio to a threshold value.

32. The method of claim 30, further comprising:
generating the first signal from at least one Hall effect sensor.

33. The method of claim 30, further comprising:
generating the first signal from at least one current transformer.

34. The method of claim 30, further comprising:
wirelessly transmitting the first signal to a controller.

35. The method of claim 30, further comprising:
detecting the first signal from a first pair of sensors, wherein the first pair of sensors is configured to detect a DC current.

36. The method of claim 30, further comprising:
detecting the first signal from a first pair of sensors, wherein the first pair of sensors is configured to detect an AC current.

37. A controller for detecting oxidation of a rail of a track, the controller configured to perform operations comprising:
receiving a first signal representing a measurement of a first portion of a current through the rail of the track;
receiving a second signal representing a measurement of a second portion of a current through the rail of the track;
comparing the measurement of the first portion of the current and the measurement of the second portion of the current;
determining, based on the comparison, a status of the oxidation; and
generating and transmitting a signal representing the status of the oxidation.

38. The controller for detecting oxidation of claim 37, wherein comparing the first measurement of the first portion of the current and the measurement of the second portion of the current includes:
determining a ratio of the measurement of the first portion of the current and the second measurement of the second portion of the current; and
comparing the ratio to a threshold value.

39. The controller for detecting oxidation of claim 37, wherein the controller is in wireless electrical communication with a first pair of sensors and a second pair of sensors.

40. The controller for detecting oxidation of claim 37, wherein the controller is in wired electrical communication with a first pair of sensors and a second pair of sensors.
